(19) United States
(12) Patent Application Publication
(10) Pub. No.: US 2007/0228295 A1
(43) Pub. Date: Oct. 4, 2007

(54) Lithographic Apparatus, Support, Device Manufacturing Method, and a Method of Supporting

(75) Inventors: Dirk-Jan Bijvoet, Eindhoven (NL); Jan Frederik Hoogkamp, Breda (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 10/562,211

(22) PCT Filed: Dec. 23, 2004
(86) PCT No.: PCT/NL04/00907

§ 371 Date: Dec. 7, 2006

(51) Int. Cl. G21K 5/10; B23Q 1/25

(52) U.S. Cl. 250/492.22; 269/55

(57) ABSTRACT

A lithographic apparatus comprising: an illumination system configured to condition a radiation beam; a support constructed to support a patterning device, the patterning device being capable of imparting the radiation beam with a pattern in its cross-section to form a patterned radiation beam; wherein the support is arranged to subject, at least when the support is accelerated, a first side of the patterning device to at least one first force normal to the direction of the acceleration so that an acceleration of the patterning device with respect to the support is counteracted by frictional forces occurring at a contact area between the patterning device and the support, wherein the support is associated with a clamping device which is arranged to subject a second side of the patterning device to at least one second force, at least when the support is accelerated.

### FIELD

The present invention relates to a lithographic apparatus, a support constructed to support a patterning device, and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In any lithographic apparatus, the mask or reticle needs to be placed at a required position with respect to the radiation beam.

The patterning device is supported by a support which can be moved in order to place said device at the required position. The position of the patterning device on a support is well-defined with respect to the support and needs said position to be fixed with respect to the support when the support is being moved. The fixation of the patterning device is usually accomplished by applying a vacuum force on at least part of the patterning device so that it is sucked against the support.

In order to enhance the throughput of such a lithographic apparatus, the patterning device is subjected to increasing accelerations, resulting in a need for increased forces required to keep the patterning device fixed at its required position. In this context accelerations may be either positive or negative. In particular in the so-called scanners, the patterning device moves rapidly while the radiation beam remains stationary and the patterning device imparts the radiation beam with a pattern in its cross-section.

### SUMMARY

It is desirable to provide a lithographic apparatus which allows for a high throughput whilst maintaining high accuracy of the intended localization of the pattern as forced upon the radiation beam. This results in a good overlay, that is a high level of correspondence between the intended position of the pattern as transferred onto a target position on a substrate and the actual position of the pattern as transferred onto that target portion of the substrate.

It is further desirable to provide a support constructed to support a patterning device and allowing for accurately projecting the pattern onto a predetermined surface using a radiation beam, even when the support is or has been subjected to a high acceleration.

It is desirable to provide a method comprising supporting a patterning device using a support that allows for accurately projecting the pattern onto a substrate even when the support is subjected or has been subjected to a high acceleration.

It is further desirable to provide a device manufacturing method comprising transferring a pattern from a patterning device onto a substrate even when the patterning device is subjected or has been subjected to a high acceleration.

According to an aspect of the invention, there is provided a support constructed to support a patterning device which patterning device is capable of imparting a radiation beam with a pattern in its cross-section to form a patterned radiation beam, wherein the support is arranged to subject, at least when the support is accelerated, a first side of the patterning device to at least one first force normal to the direction of the acceleration so that an acceleration of the patterning device with respect to the support is counteracted by frictional forces occurring at a contact area between the patterning device and the support, wherein the support is associated with a clamping device which is arranged to subject a second side of the patterning device to at least one second force normal to the direction of the acceleration of the support, at least when the support is accelerated

According to an aspect of the invention, there is provided that a device manufacturing method comprising transferring a pattern from a patterning device onto a substrate, wherein the method comprises supporting the patterning device using a support; accelerating the support, subjecting a first side of the patterning device to at least one first force normal to the direction of the acceleration so that an acceleration of the patterning device with respect to the support is suppressed by frictional forces occurring at a contact area between the patterning device and the support; and

subjecting a second side of the patterning device to at least one second force normal to the direction of the acceleration of the support, at least when the support is accelerated.

According to an aspect of the invention, there is provided a method comprising supporting a patterning device using a support; accelerating the support; subjecting a first side of the patterning device to a first force normal to the direction of the acceleration so that an acceleration of the patterning device with respect to the support is counteracted by frictional forces occurring at a contact area between the patterning device and the support; and

subjecting a second side of the patterning device to a second force normal to the direction of the acceleration of the support, at least when the support is accelerated.

According to an aspect of the invention, there is provided a lithographic apparatus comprising an illumination system configured to condition a radiation beam; a support constructed to support a patterning device, the patterning device being capable of imparting the radiation beam with a pattern in its cross-section to form a patterned radiation beam; wherein the support is arranged, to subject at least when the support is accelerated, a first side of the patterning device to at least one first force normal to the direction of the acceleration so that an acceleration of the patterning device with respect to the support is counteracted by frictional forces occurring at a contact area between the patterning device and the support, wherein the support is associated with a clamping device which is arranged to subject a second side of the patterning device to at least one second force normal to the direction of the acceleration of the support, at least when the support is accelerated.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a part of a lithographic apparatus according to an embodiment of the invention;

FIG. 3 depicts a part of a lithographic apparatus according to an embodiment of the invention;

FIG. 4 depicts a part of a lithographic apparatus according to an embodiment of the invention;

FIG. 5 depicts a part of a lithographic apparatus according to an embodiment of the invention;

FIG. 6 depicts a part of a lithographic apparatus according to an embodiment of the invention;

FIG. 7 depicts a part of a lithographic apparatus according to an embodiment of the invention; and

FIG. 8 depicts a part of a lithographic apparatus according to an embodiment of the invention.

### DETAILED DESCRIPTION

In the drawings like-parts have like-references.

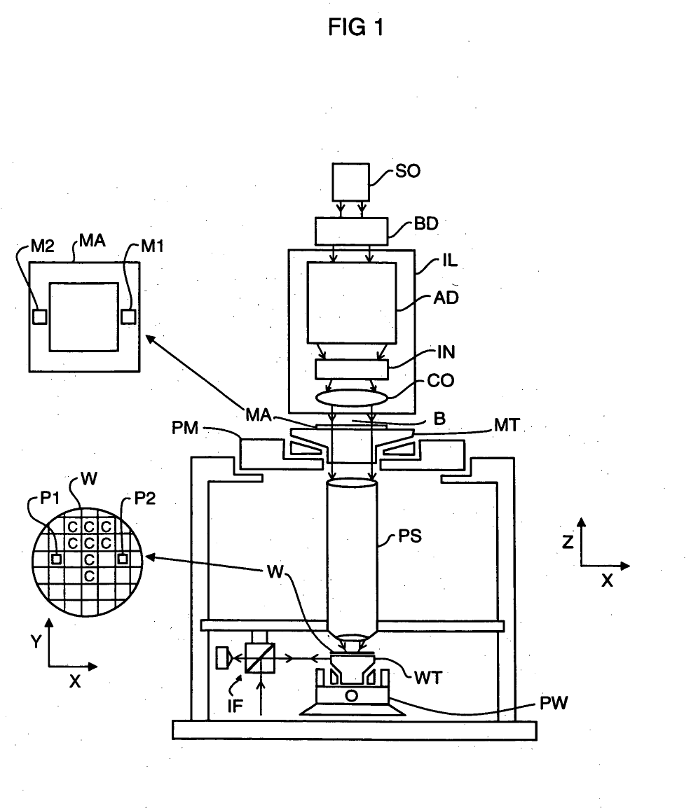

FIG. 1 schematically depicts a lithographic apparatus according to one embodiment of the invention. The apparatus comprises:
an illumination system (illuminator) IL configured to condition a radiation beam B (e.g. UV radiation).
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which is movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:
1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

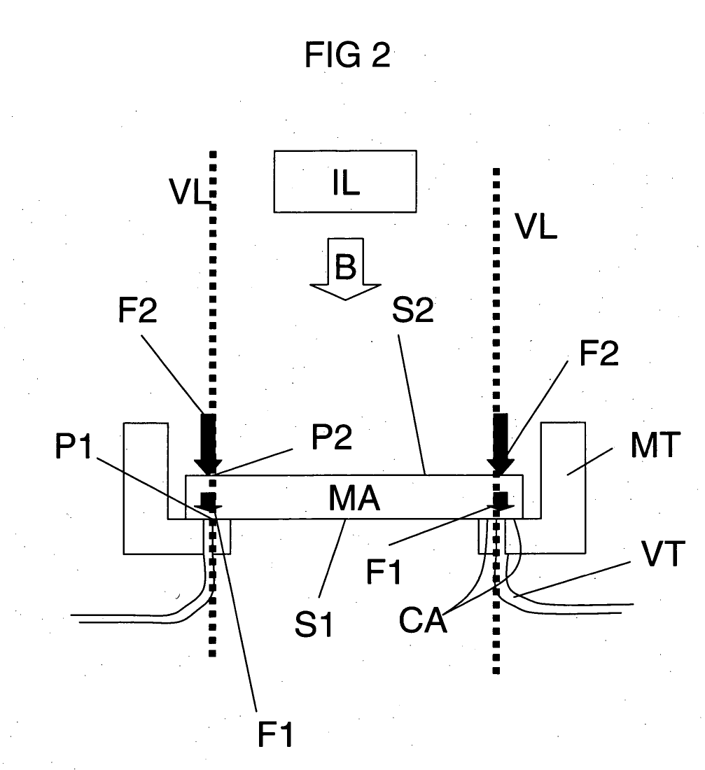

All the FIGS. 2-8, are intended to be schematic figures and are symmetrical with respect to the line drawn by the radiation beam B.

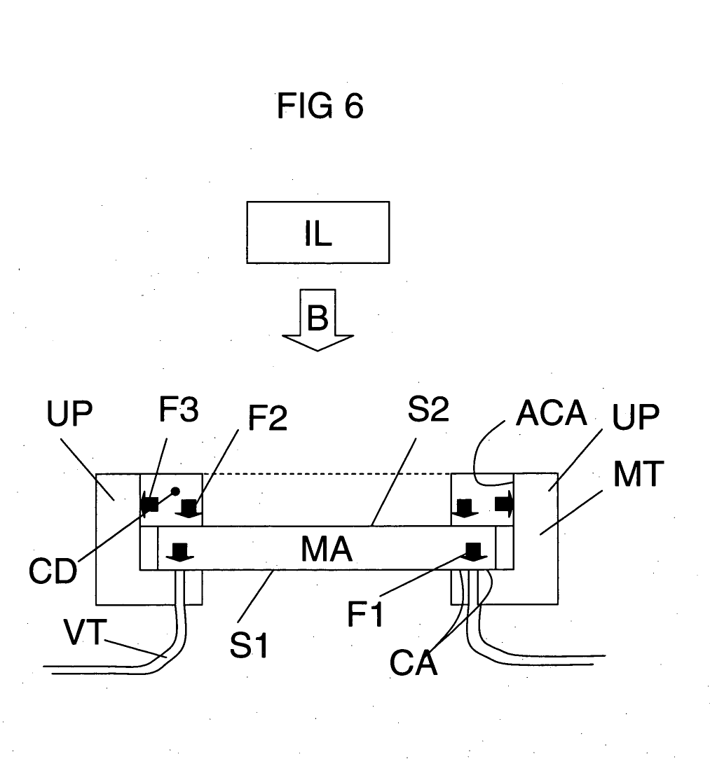

FIG. 2 shows a part of a lithographic apparatus according to the invention. The part shown comprises an illumination system IL configured to condition a radiation beam B. The part shown further comprises a support MT which is in this exemplary embodiment a mask table, constructed to support a patterning device MA which is in this embodiment a mask. The patterning device MA is capable of imparting the radiation beam B with a pattern in its cross-section to form a patterned radiation beam. The support MT is arranged to exert, at least when the support MT is accelerated, first forces F1 normal to the direction of the acceleration to at least part of a first side S1 of the patterning device MA so that an acceleration force acting on the patterning device MA relative to the support MT is counteracted by frictional forces occurring at a contact area CA between the patterning device MA and the support MT. To this end, vacuum tubes VT are used to clamp the mask MA to the support MT. These frictional forces are, as is well known, proportional to the normal forces F1. In other words, an acceleration of the patterning device MA with respect to the support MT is counteracted by a frictional force directed in an opposite direction that is the result of normal forces F1. In the FIGS. 2-4 and the FIGS. 6-8, the direction of acceleration of the patterning device MA is considered to be perpendicular to the plane in which the drawing is presented.

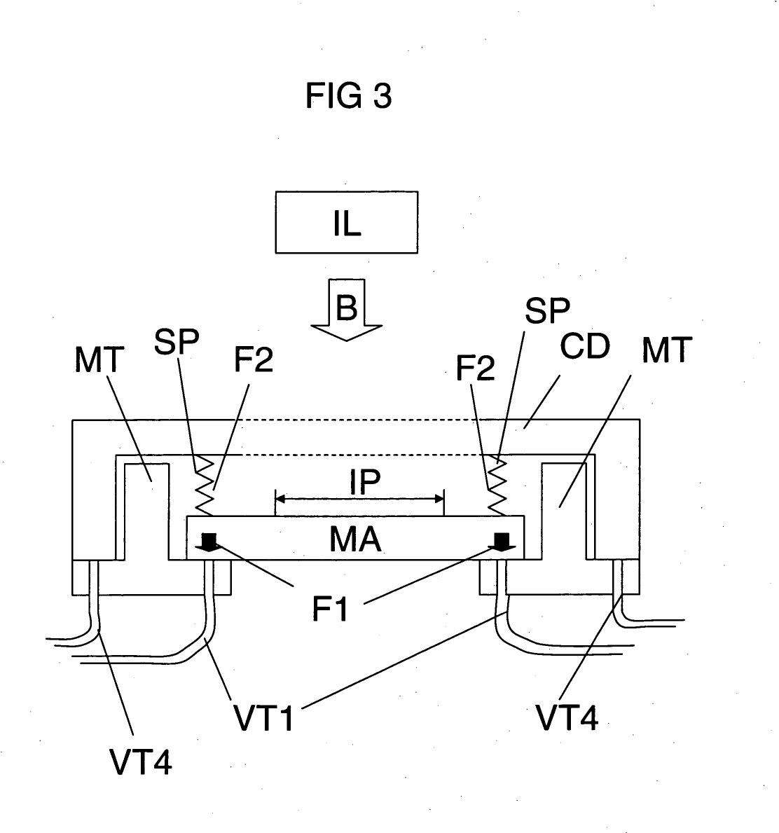

The support MT is associated with a clamping device CD (as shown in FIG. 3) which is arranged to exert second forces F2 normal to the direction of the acceleration of the support MT to at least part of a second side S2 of the patterning device MA, at least when the support MT is accelerated. FIG. 2 shows schematically that second forces F2 may substantially be exerted such that the main direction in which the second faces F2 act substantially coincides with the main direction of the respective first forces F1, as is indicated with a dotted line VL.

FIG. 3 shows an embodiment in which an example of a clamping device CD is shown comprising a resilient structure SP for providing said additional clamping force by push pressure. In this embodiment the clamping device CD is arranged such that no interference occurs with the radiation beam B. To this end, the clamping device may comprise a (illustrated by dotted lines) central open part, allowing passage to the radiation beam B. The forces F2, as in use exerted by the clamping device CD, are exerted such that only those parts of the patterning device MA which are supported by the support MT, are subjected to the second forces F2. Consequently, the second forces F2 are preferably exerted such that the central part, in particular the image plane IP of the patterning device MA is only minimally deformed, if at all and no additional bending moments are introduced to the patterning device MA. In the embodiment shown in FIG. 3, the clamping device CD is arranged to provide the second force F2, while minimizing areas of contact at which frictional forces can act between the clamping device CD and the patterning device MA when the patterning device MA is accelerated with respect to the clamping device CD.

In the embodiment shown in FIG. 3 the clamping device CD is arranged to exert the second forces F2 passively. Thus, in this example no active control is present regarding the amount of additional clamping pressure that is exerted. As shown this can be done by using a resilient member SP such as for example a spring, which also is arranged to minimize the contact area between the clamping device CD and the patterning device MA. By minimizing the contact area, no additional bending moments are introduced and the first clamping force F1 and additional second clamping force F2 are kept substantially aligned. It is also possible to exert the second forces F2 via other passive mechanisms. Conceivable is the use of two equal magnetic poles facing each other; one magnet associated with the clamping device CD and the other magnet associated with the patterning device MA.

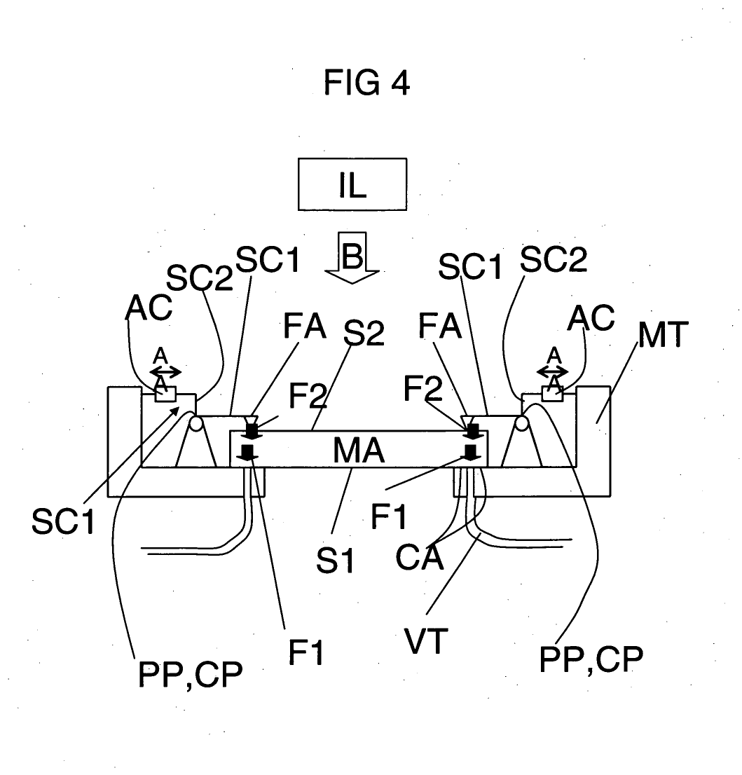

In contrast to the passive embodiment shown in FIG. 3, it is also possible to exert the second forces F2 actively using an actuator, such as will for example be demonstrated with reference to FIG. 4. Such an actuator may for instance have a pneumatic or electromagnetic driving mechanism, both well known in the art.

In the embodiment shown in FIG. 3 the clamping device is removable. This allows for access to the patterning device MA when the patterning device MA needs to be exchanged. As shown, the clamping device CD is removably connected to the support MT. In this example the clamping device CD is actively connected to the support, as shown in FIG. 3, by vacuum techniques. Indeed, in FIG. 3 tubes VT4 are present to provide a connection by applying a vacuum pressure. A connected condition is provided by vacuum pressure which is exerted on a face of the clamping device CD, which clamping device CD is thereby sucked and actively connected to the support MT. It is also possible to provide such an active connection using other clamping elements, such as an electrostatic clamping element and/or by electromagnetic forces etc. It is also possible to passively connect the clamping device CD to the support MT. Permanent magnets may for instance be employed for providing a connection for connecting the clamping device CD to the support MT. In the embodiment shown in FIG. 3, the first forces F1 are exerted by vacuumizing tubes VT1, which extend through the support MT. A contact area CA (see FIG. 4) is provided against which the patterning device MA is sucked, when the vacuum tube VT is vacuumized. The clamping device CD, applies a second forces F2 which further push the patterning device MA against the contact area CA. In this example, first forces F1 are exerted independently of the application of the second force F2. As the total normal force acting on the contact area CA is increased from F1 to F1+F2, the frictional force has also increased.

Although in the embodiments shown the first and second side S1, S2 of the patterning device are substantially parallel to each other it is possible the sides are non-parallel as well.

FIG. 4 shows a further embodiment of a support according to the invention. Here, the clamping device CD comprises a pivoting lever assembly SC, said assembly being pivotable around a pivot that is in fixed positional relationship to said support and comprising an lever part SC2 contacting said patterning means so as to provide an additional clamping pressure on said patterning means while being pivoted, and an actuator AC arranged said pivot said pivoting lever assembly. In this embodiment the clamping forces F2 for clamping the patterning device MA to the support MT are provided by a force applicator FA. The force applicator FA is connected by means of a lever assembly comprising a first lever part SC1 and a second lever part SC2. The second lever part is connected with an actuator AC. The lever assembly SC is substantially L-shaped, wherein the lever parts SC1, SC2 each form one leg thereof respectively. Lever parts SC1 and SC2 are connected to each other at their intersection point CP. The intersection point CP coincides with a pivotal point PP around which the lever assembly SC can pivot when the actuator AC actuates. The actuator AC may comprise for instance, an electromagnetic driving mechanism, a pneumatic driving mechanism etc. At least when the support MT is accelerated, the actuator AC acts on the lever assembly such that the force applicator FA exerts clamping force F2 on the patterning device MA that pushes the patterning device MA firmly against the support MT. When the patterning device MA needs to be exchanged, the actuator AC may actuate such that the force applicator FA is lifted from the patterning device MA by pivoting the level assembly SC about the pivotal point PP. Arrows AA indicate the direction into which the actuator AC may actuate. It is clear from FIG. 4 that an additional force is provided substantially in the same direction as the force F1, which results in an increased total clamping force to hold the patterning device correctly positioned during movement of the support MT even under high accelerations thereof. Furthermore these additional clamping forces are preferably provided via a small contact interface, thereby minimizing areas of contact at which frictional forces can act between the clamping device CD and the patterning device MA when the patterning device MA is accelerated with respect to the clamping device CD. Furthermore, the clamping arrangement comprising force applicator FA as disclosed in FIG. 4, may in an alternative embodiment dynamically exert an additional clamping force in response to a sensed acceleration of the support. To this end, the clamping forces may be increased by means of actuator AC depending on the magnitude of a sensed acceleration, for example, by an accelerometer that is mounted on the support MT or by telemetry that derives the acceleration of the support MT by interferometric measurements.

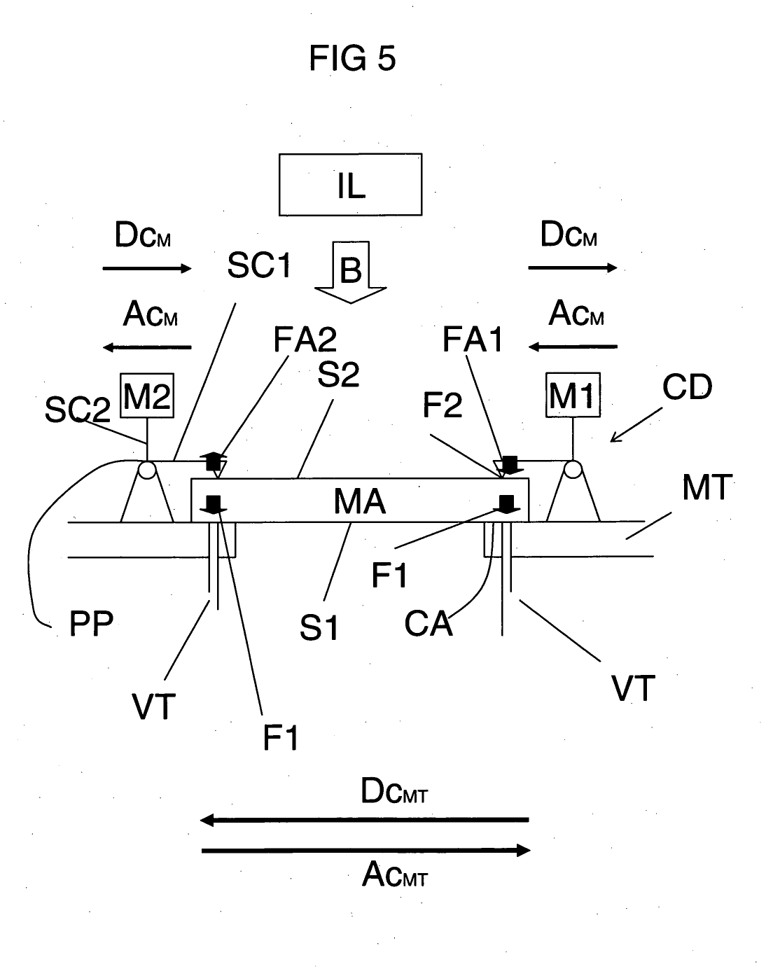

FIG. 5 shows another embodiment of a support MT according to the invention. Here, as in FIG. 4, a pivoting lever assembly SC is illustrated. The assembly SC is pivotable around a pivot PP that is in fixed positional relationship to said support MT and comprising a lever part SC2 contacting said patterning means MA so as to provide an additional clamping pressure on said patterning means while being pivoted. The assembly SC comprises an inertial mass elements M1, M2, fixedly connected to the pivoting assembly so as to pivot the assembly during accelerations. In particular, the clamping device CD comprises two masses M1, M2 which may provide a clamping force depending on a direction of acceleration. For one direction, an acceleration of the support MT is indicated by an arrow Ac_{MT} and is within the plane in which the drawing is presented. Through the inertia of masses M1, M2, a counterforce is generated which is represented by a reverse acceleration direction Acm, opposite to the acceleration Ac_{MT}. These respective counterforces acted on M1 and M2 are redirected via pivotal point PP, in a direction transverse to the acceleration direction ACm. For mass M2, this results in a transverse force FA2 that is oriented upwards. This force FA2 does not contribute to an additional clamping force. For mass M1, however, the transverse force FA1 is oriented downwards and provides an additional clamping force for clamping the patterning device MA to the support MT.

In the reverse case the support MT undergoes a reverse acceleration (deceleration) DCmt. Again a counter force acts on the respective masses M1 and M2 and now provides, via pivoting parts PP, for M2 an additional clamping force FA2, which is now (contrary to the illustrated case) oriented in the direction of the support MT.

FIG. 6 shows another embodiment of a support MT according to the invention. In this embodiment the clamping device CD is arranged to abut the support. The clamping device may itself be clamped between upright parts UP of the support MT as illustrated by clamping force F3, for example, by clamp fitting the clamping device CD against the additional contact area ACA. Thus, the shapes and positions of clamping device CD and upstanding parts UP are corresponding and shaped to be fitted to each other.

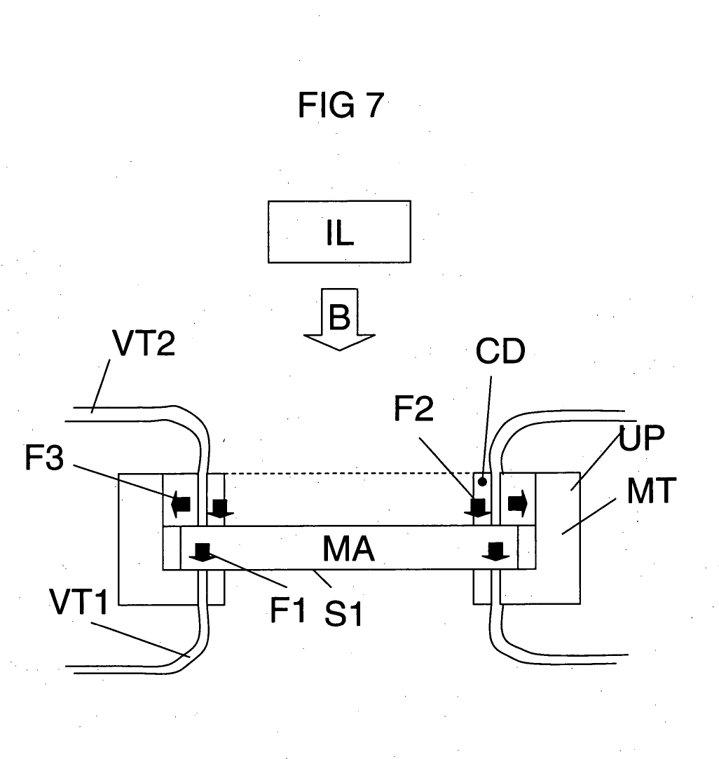

As shown in FIG. 7, the clamping device CD may also be provided with vacuum tubes VT2. In this embodiment a very stiff construction can be obtained for maintaining the position of the clamping device and the patterning device MA when the support MT is accelerated. In this embodiment the patterning device MA is fixedly attached by vacuum suction to the clamping device CD, which is held against upstanding edges UP of the support.

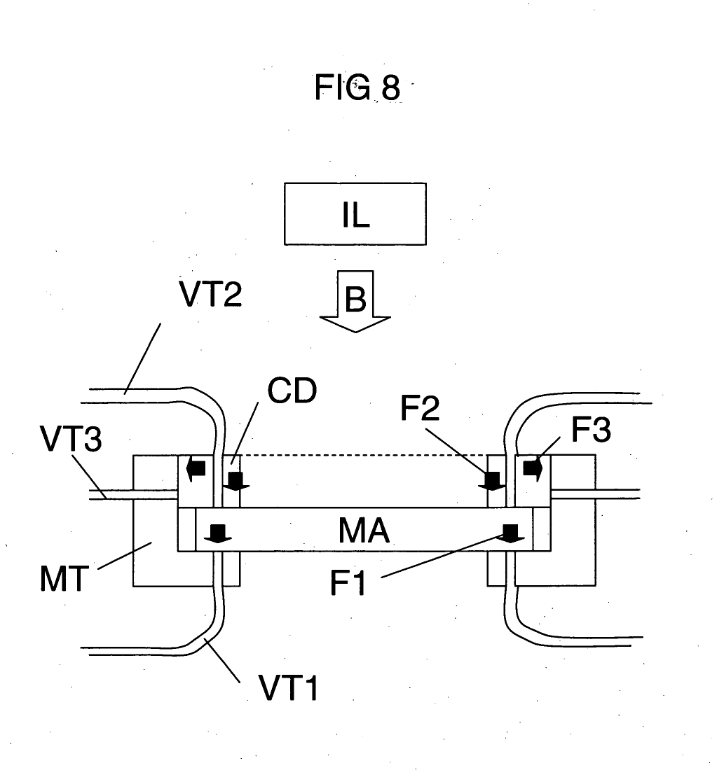

FIG. 8 shows another embodiment of a support MT according to the invention. In this example, a vacuum tube VT3 extends through the upright parts UP of the support MT to which the clamping device CD abuts when obtaining the additional contact area ACA. When vacuum is applied to vacuum tube VT3 the clamping device will be sucked against the support MT, thus increasing force F3 to stabilize the clamping device CD in the support MT.

It will be clear that the invention aims to maintain the position of the patterning device MA with respect to the support MT, not only when a positive acceleration of the support occurs, but equally when a negative acceleration, i.e. a deceleration of the support occurs.

It should further be borne in mind that although in all the embodiments shown the patterning device is oriented substantially horizontally, the invention is by no means limited to such an orientation of the patterning device. It is also possible that the beam is vertically or diagonally oriented and that as a consequence thereof or because of any reason the patterning device is oriented vertically or diagonally.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A lithographic apparatus comprising:
an illumination system configured to condition a radiation beam;
a support constructed to support a patterning device, the patterning device being constructed and arranged to impart the radiation beam with a pattern in its cross-section to form a patterned radiation beam;
wherein the support is arranged to subject, at least when the support is accelerated, a first side of the patterning device to at least one first force normal to the direction of the acceleration so that an acceleration of the patterning device with respect to the support is counteracted by frictional forces occurring at a contact area between the patterning device and the support, wherein the support is associated with a clamping device which is arranged to subject a second side of the patterning device to at least one second force, at least when the support is accelerated.

2. A lithographic apparatus according to claim 1, wherein the first and second side of the patterning device are situated substantially opposite each other.

3. A lithographic apparatus according to claim 1, wherein the clamping device is arranged to provide the at least one second force substantially coinciding with the at least one first force.

4. A lithographic apparatus according to claim 1, wherein the clamping device is arranged to provide the at least one second force while minimizing areas of contact of which frictional forces can act between the clamping device and the patterning device when the patterning device is accelerated with respect to the clamping device.

5. A lithographic apparatus according to claim 1, wherein the clamping device is arranged to exert the at least one second force actively.

6. A lithographic apparatus according to claim 1, wherein the clamping device is arranged to exert the at least one second force passively.

7. A lithographic apparatus according to claim 1, wherein the clamping device is removable.

8. A lithographic apparatus according to claim 7, wherein the clamping device is actively connectable to the support.

9. A lithographic apparatus according to claim 7, wherein the clamping device is passively connectable to the support.

10. A lithographic apparatus according to claim 1, wherein the clamping device is connected to the support.

11. A lithographic apparatus according to claim 10, wherein the clamping device is arranged to dynamically exert the at least one second force when the support is being accelerated.

12. A lithographic apparatus according to claim 11, wherein the clamping device comprises at least one mass which accelerates differently with respect to an acceleration of the support, each mass thereby capable of generating a force that is transmissible for exerting the at least one second force.

13. A lithographic apparatus according to claim 1, wherein the clamping device is arranged to provide additional contact area for enhancing the frictional forces needed to overcome to cause acceleration of the patterning device relative to the support when the support is accelerated.

14. A lithographic apparatus according to claim 1, wherein the clamping device is arranged to abut the support.

15. A lithographic apparatus according to claim 1, wherein the lithographic apparatus is provided with a handler for handling the patterning device with respect to the support, wherein the handler is also arranged to handle the clamping device.

16. A support constructed to support a patterning device which is capable of imparting a radiation beam with a pattern in its cross-section to form a patterned radiation beam;
the support being arranged to subject, at least when the support is accelerated, a first side of the patterning device to a clamping force, and wherein the support is associated with a clamping device which is arranged to subject a second side of the patterning device, extending in a plane that is non-coinciding with the first side, to an additional clamping force, at least when the support is accelerated.

17. A support according to claim 16, wherein the first and second side of the patterning device are situated substantially opposite each other.

18. A support according to claim 16, wherein the clamping device is connected to said support by clamping elements.

19. A support according to claim 18, wherein said clamping elements comprise vacuum suction tubes.

20. A support according to claim 19, wherein the clamping device is shaped to be connected to said support by clamp fitting.

21. A support according to claim 16, wherein said clamping device comprises a resilient structure for providing said additional clamping force by push pressure.

22. A support according to claim 16, wherein said clamping device comprises a pivoting lever assembly, said lever assembly being pivotable around a pivot that is in fixed positional relationship to said support and comprising a lever part contacting said patterning means so as to provide an additional clamping pressure on said patterning means while being pivoted, and an actuator arranged to pivot said pivoting lever assembly.

23. A support according to claim 16, wherein said clamping device comprises a pivoting lever assembly, said assembly being pivotable around a pivot that is in fixed positional relationship to said support and comprising a lever part contacting said patterning means so as to provide an additional clamping pressure on said patterning means while being pivoted wherein the assembly comprises an inertial mass element, fixedly connected to the pivoting assembly so as to pivot the assembly during accelerations.

24. A device manufacturing method comprising
transferring a pattern from a patterning device onto a substrate
supporting the patterning device using a support;
accelerating the support,
subjecting a first side of the patterning device to at least one first force normal to the direction of the acceleration so that an acceleration of the patterning device with respect to the support is suppressed by frictional forces occurring at a contact area between the patterning device and the support; and
subjecting a second side of the patterning device to at least one second force normal to the direction of the acceleration of the support, at least when the support is accelerated.

25. A method according to claim 24, wherein the first and second side of the patterning device are situated substantially opposite each other.

26. A method according to claim 24, wherein the method comprises providing the second force substantially coinciding with the at least first force.

27. A method according to claim 24, wherein the method comprises providing the at least one second force while minimizing areas of contact at which frictional forces can act between the clamping device and the patterning device when the patterning device is accelerated with respect to the clamping device.

28. A method according to claim 24, wherein the method comprises exerting the at least one force actively.

29. A method according to claim 24, wherein the method comprises exerting the at least one force passively.

30. A method according to claim 24, wherein the clamping device is movable.

31. A method according to claim 30, wherein the method comprises actively connecting the clamping device to the support.

32. A method according to claim 30, wherein the method comprises passively connecting the clamping device to the support.

33. A method according to claim 24, wherein the clamping device is connected to the support.

34. A method according to claim 33, wherein the clamping device dynamically applies the at least one second force when the support is being accelerated.

35. A method according to claim 34, wherein the clamping device comprises at least one mass which accelerates differently with respect to an acceleration of the support, each mass thereby capable of counteracting a force that is transmissible for exerting the at least one second force.

36. A method according to claim 24, wherein the method comprises providing contact area between the clamping device and the support for enhancing the frictional forces needed to overcome to cause acceleration of the patterning device relative to the support when the support is accelerated.

37. A method according to claim 24, wherein the method comprises abutting of the clamping device and the support.

38. A method according to claim 24, wherein the method comprises handling the patterning device with respect to the support using a handler which is also arranged to handle the clamping device.

39. A method comprising:
supporting a patterning device using a support;
accelerating the support;
subjecting a first side of the patterning device to at least one first force normal to the direction of the acceleration so that an acceleration of the patterning device with respect to the support is suppressed by frictional forces occurring at a contact area between the patterning device and the support; and
subjecting a second side of the patterning device to at least one second force normal to the direction of the acceleration of the support, at least when the support is accelerated.

40. (canceled)

41. (canceled)
